(19) United States
(12) Patent Application Publication
(10) Pub. No.: US 2026/0078293 A1
(43) Pub. Date: Mar. 19, 2026

(54) REGENERATOR MATERIAL, REFRIGERATOR AND SUPERCONDUCTING COIL INCORPORATING APPARATUS

(71) Applicant: KABUSHIKI KAISHA TOSHIBA, Tokyo (JP)

(72) Inventors: Naoki KUROKAWA, Kawasaki Kanagawa (JP); Takahiro KAWAMOTO, Yokohama Kanagawa (JP); Tomoe KUSAMA, Bunkyo Tokyo (JP); Masaya HAGIWARA, Yokohama Kanagawa (JP); Shinya SAKURADA, Saitama Saitama (JP)

(73) Assignee: KABUSHIKI KAISHA TOSHIBA, Tokyo (JP)

(21) Appl. No.: 19/286,853

(22) Filed: Jul. 31, 2025

(30) Foreign Application Priority Data
Sep. 18, 2024 (JP) 2024-160676

(51) Int. Cl. C09K 5/14; C01B 33/06; H01F 6/04; H01F 6/06

(52) U.S. Cl. CPC C09K 5/14; C01B 33/06; C01P 2002/52; C01P 2002/60; C01P 2004/61; C01P 2006/32; F25B 2309/003; H01F 6/04; H01F 6/06

(57) ABSTRACT

According to an embodiment, there is provided a regenerator material including an intermetallic compound represented by a compositional formula ErₐFe_{b}Si_{100-a-b} (where 15≤a≤25, and 35≤b≤45), the intermetallic compound including a crystalline phase with a ThCr₂Si₂-type crystal structure as a main phase, and the crystal grain size of the main phase being 0.001 mm or more and 1 mm or less.

### CROSS-REFERENCE TO RELATED APPLICATION(S)

This application is based upon and claims the benefit of priority from Japanese Patent Application No. 2024-160676, filed Sep. 18, 2024, the entire contents of which are incorporated herein by reference.

### FIELD

Embodiments described herein relate generally to a regenerator, a refrigerator, and a superconducting coil incorporating apparatus.

### BACKGROUND

Superconducting electromagnets used in magnetic resonance imaging systems (MRI), heavy particle accelerators, and the like operate in an environment below several tens of Kelvin. This environment is usually realized by a cold storage type refrigerator represented by a Gifford-McMahon (GM) refrigerator. In addition, in recent years, an environment of several mK is required for next-generation devices such as quantum computers, and a dilution refrigerator is used to realize the environment. A cold storage type refrigerator is used as a component of the dilution refrigerator, and is responsible for pre-cooling to a temperature equal to or lower than 4K.

In the refrigerator, several kinds of regenerator material having high specific heat are used for each temperature range to be used. In the GM refrigerator widely used at present, a Cu mesh is used as a regenerator in the first stage, spherical particles of Pb or Bi alloy are used as a regenerator material on the high temperature side of the second stage regenerator, and particles of a rare earth compound such as Gd₂O₂S (GOS), HoCu₂, or Er₃Ni are used as a regenerator material on the low temperature side of the second stage regenerator. Among such regenerator materials, GOS has high specific heat characteristics in a temperature region near 5K.

In order to synthesize an oxide regenerator material such as GOS, a multi-step process is required, such as synthesis of a raw material, granulation, sintering at a high temperature, and finishing into a true sphere by polishing.

In a refrigerator such as a GM refrigerator, a pulse tube refrigerator, or a Stirling refrigerator, a high-pressure working gas flows back and forth through gaps in a regenerator material filled in the regenerator. Further, in the GM refrigerator and the Stirling refrigerator, the regenerator filled with the regenerator material vibrates. Therefore, the regenerator material is required to have mechanical strength.

In contrast to oxides that require a multi-step manufacturing process such as synthesis of raw materials, granulation, sintering at high temperature, and finishing into a true sphere by polishing, intermetallic compounds that can be manufactured by a simple process of melting and solidifying are preferable from the viewpoint of manufacturing the regenerator material.

It is known that a DyCu₂Ge₂ compound having a ThCr₂Si₂-type crystal structure has good manufacturability and a high peak specific heat value in the vicinity of 6K. However, since the DyCu₂Ge₂ compound has a small specific heat at a temperature equal to or lower than 5K, the refrigeration capacity of the refrigerator decreases in temperature ranges at or below 5K.

It is known that an ErFe₂Si₂ compound having a ThCr₂Si₂-type crystal structure has a high peak specific heat value in the vicinity of 3K. However, the ErFe₂Si₂ compound has a sharp specific heat peak shape, and thus the integrated value of the specific heat peak in the range of 2K to 5K is small, which causes a decrease in the refrigeration capacity of the refrigerator.

### BRIEF DESCRIPTION OF THE DRAWINGS

FIG. 1 is a schematic view illustrating a part of a crystal phase of a regenerator material according to an embodiment.

FIG. 2 is a schematic view illustrating a shape of the regenerator material 1 according to the embodiment.

FIG. 3 is a cross-sectional view of a two-stage expansion type GM refrigerator exemplified as the refrigerator according to the embodiment.

FIG. 4 is a sectional view of an MRI apparatus exemplified as a superconducting coil incorporating apparatus according to the embodiment.

FIG. 5 is a graph showing specific heat characteristics from 2K to 6K in Example 1 and Comparative Examples 11 to 13.

FIG. 6 is a SEM image of the sample of Example 1 observed at 5000× magnification.

### DETAILED DESCRIPTION

In general, according to an embodiment, a regenerator material includes an intermetallic compound represented by a composition formula ErₐFe_{b}Si_{100-a-b} (where 15≤a≤25, and 35≤b≤45), wherein the intermetallic compound has a crystalline phase having a ThCr₂Si₂-type crystal structure as a main phase, and a crystal grain size of the main phase is 0.001 mm or more and 1 mm or less.

Hereinafter, embodiments will be described with reference to the drawings. In the following description, components having the same or similar functions are denoted by the same reference numerals throughout the drawings, and redundant description thereof will be omitted. The drawings are schematic views for explaining the embodiments and promoting the understanding thereof, and the shapes, dimensions, ratios, and the like thereof may be different from those of an actual device, but these can be appropriately changed in design in consideration of the following description and known techniques.

In the present specification, the cryogenic region is a temperature range from 2K to 5K. Hereinafter, the temperature range from 2K to 5K may be referred to as the cryogenic temperature region.

### First Embodiment

In the first embodiment, the regenerator material will be described. The regenerator material according to the embodiment includes an intermetallic compound represented by a compositional formula ErₐFe_{b}Si_{100-a-b} (15≤a≤25, 35≤b≤45, the intermetallic compound has a crystalline phase having a ThCr₂Si₂-type crystal structure as a main phase, and a crystal grain size of the main phase is 0.001 mm or more and 1 mm or less.

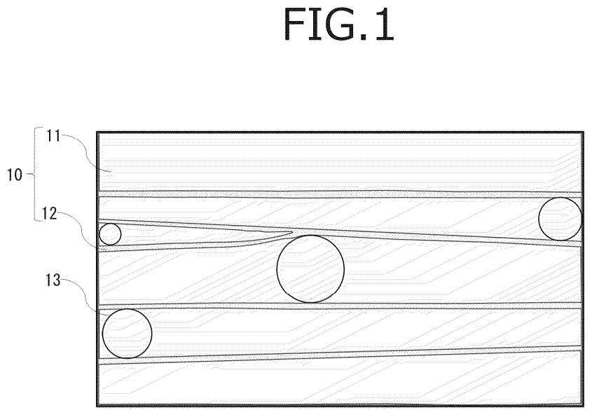

FIG. 1 is a schematic view illustrating a part of a crystal phase of a regenerator material according to an embodiment. In FIG. 1, the main phase 11 is present at six positions. The grain boundary phase 12 exists between the main phases 11. The main phase 11 extends in the major axis direction. The crystal phase 10 of the regenerator material 1 according to the embodiment includes a main phase 11 and a grain boundary phase 12. The crystal phase 10 of the regenerator material 1 is, for example, a columnar crystal. The crystal phase 10 extends over a length of several hundred micrometers. The volume ratio of the main phase 11 is larger than that of the grain boundary phase 12 in the regenerator material 1, and the grain boundary phase 12 is present around the main phase 11.

The main phase 11 is composed of a compound represented by a composition formula ErₐFe_{b}Si_{100-a-b}. By setting the composition and the stoichiometric ratios of Er, Fe, and Si to 15≤a≤25, 35≤b≥45, and 30≤100-a-b≤50, respectively, the specific heat can be increased particularly in a range of 2K to 4K. The most desirable stoichiometric ratio of Er, Fe and Si is 1:2:2. Therefore, the value of 100-a-b is preferably 35 or more and 45 or less.

The main phase 11 is a phase having a ThCr₂Si₂-type crystal structure, and occupies 50 vol % or more of the crystal phase 10 of the regenerator material 1. The main phase 11 is preferably 80 vol % or more. When the main phase 11 is 80 vol % or more, a regenerator material having higher specific heat characteristics in a low temperature region of several tens of Kelvin or less can be obtained.

The grain boundary phase 12 is composed of a compound other than the compound represented by the composition formula ErₐFe_{b}Si_{100-a-b} of the main phase 11. The grain boundary phase 12 is, for example, expressed by a composition formula Fe_{c}Si_{100-c} (45≤c≤55) or/and Er_{d}Fe_{c}Si_{f}O_{100-d-e-f} (10≤d≤20, 20≤e≤30, 40≤f≤50). The presence of the above-described compound, which is not the compound of the main phase 11, in the crystal phase 10 can improve the mechanical strength of the regenerator material particle. The grain boundary phase 12 is preferably 1 vol % or more and 20 vol % or less.

Whether the regenerator material 1 contains an intermetallic compound represented by the composition formula ErₐFe_{b}Si_{100-a-b} (15≤a≤25, 35≤b≤45) can be confirmed by analysis using a scanning electron microscope (SEM), an energy dispersive X-ray spectrometry (EDX, SEM-EDX) or the like.

Whether or not the crystal phase 10 includes a crystal phase having a ThCr₂Si₂-type crystal structure can be measured by using a powder X-ray diffraction method (X-ray diffraction; XRD), a transmission electron microscope (Transmission Electron Microscope; TEM), or the like. The volume percentage of the main phase can be calculated by fitting the XRD pattern of the crystal phase based on a crystal structure model using Rietveld analysis, or from an observation image by SEM.

The crystal grain size of the main phase 11 is 0.001 mm or more and 1 mm or less. The crystal grain size will be described with reference to FIG. 1. First, the surface of the regenerator material 1 is exposed by beam processing or polishing so that the crystal phase 10 of the regenerator material 1 can be observed. Next, the crystal phase 10 is observed by SEM. At this time, the observation is performed so that the number of the main phases 11 in the image is 3 or more. At this magnification, the main phase 11 and the grain boundary phase 12 in the image can be distinguished. The image to be observed is, for example, FIG. 1. Next, in all the main phases 11 sandwiched between the grain boundary phases 12 or surrounded by the grain boundary phases 12 among the main phases 11 in the image, one inscribed circle 13 which is in contact with two grain boundary phases 12 and is the largest in the image is drawn for each main phase 11, and the diameter of the inscribed circle 13 is measured. A plurality of inscribed circles 13 may be drawn in the same main phase 11 as long as the images show different regions. This makes it possible to obtain a more accurate value of the crystal grain size. In FIG. 1, four inscribed circles 13 are drawn in four main phases 11. Then, the SEM image is observed again so that three or more main phases 11 are included in the unobserved region, and the inscribed circle 13 is drawn in the same manner as described above, and the diameter of the inscribed circle 13 is measured. The SEM image observation and the measurement of the diameter of the inscribed circle 13 are performed until 100 inscribed circles 13 are drawn, and the average diameter of all the 100 inscribed circles 13 is defined as the crystal grain size.

When the crystal grain size is in the range of 0.001 mm to 1 mm, the particles of the regenerator material have good specific heat characteristics and mechanical strength. When the crystal grain size is increased, the integral value of the specific heat peak is increased in the cryogenic temperature region, and a regenerator material having excellent specific heat characteristics can be obtained. From the viewpoint of mechanical strength, the crystal grain size is preferably 0.1 mm or less.

In the main phase 11 and the grain boundary phase 12, a part of Er, Fe, and Si may be substituted with other elements. For example, a part of Er may be substituted with R (R is one or more elements selected from La, Ce, Pr, Nd, Pm, Sm, Eu, Gd, Tb, Dy, Ho, Tm, Yb, Lu, Sc and Y). Further, a part of Fe may be substituted with T (T is one or more elements selected from Ti, V, Cr, Mn, Co, Ni, Cu, Nb, Zr, Mo, Ru, Rh, Pd and Ag). Further, a part of Si may be substituted with X (X is one or more elements selected from B, Al, P, Ga, Ge, As, Sn, Sb and Te). The element substitution may be performed on all Er, Fe, and Si, or may be performed on only one or two elements. The substitution ratio of R to Er in the main phase 11 is preferably 50% or less. The substitution ratio of T to Fe in the main phase 11 is preferably 50% or less. The substitution ratio of X to Si in the main phase 11 is preferably 50% or less.

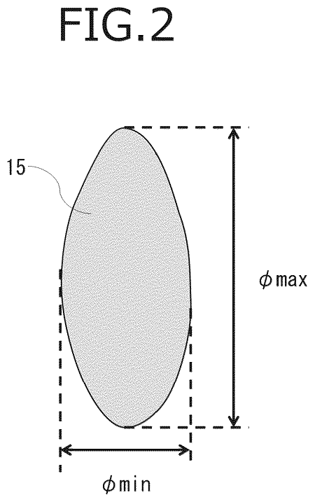

FIG. 2 is a schematic view illustrating the shape of the regenerator material 1 according to the embodiment. Here, the regenerator material 1 is described as a granular material. In FIG. 2, in the projection image 15 of the particle of the regenerator material 1 and the particle diameter φ of the regenerator material 1, the length in the longest direction of the particle is φ max, and the length of the longest portion in the direction perpendicular to the longest direction is φ min. It is preferable that both φ max and φ min are included in the range of 0.01 mm or more and 0.1 mm or less. When the particle diameter φ is within this range, in a refrigerator described below, the flow of a working gas (He gas or the like) which reciprocates in a regenerator filled with the regenerator material is not hindered, and the pressure loss of the gas is reduced. Further, the filling rate of the regenerator material in the regenerator increases, and good heat exchange between the working gas and the regenerator material is realized.

### Second Embodiment

In the second embodiment, a refrigerator will be described. The refrigerator according to the embodiment includes the regenerator material according to the first embodiment.

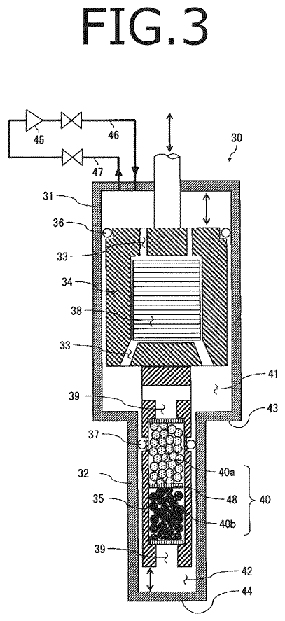

FIG. 3 is a cross-sectional view of a two-stage expansion type GM refrigerator exemplified as the refrigerator 30 according to the embodiment. The refrigerator 30 includes a first cylinder 31 having a large diameter and a second cylinder 32 having a small diameter and coaxially connected to the first cylinder 31. A first regenerator 34 is disposed in the first cylinder 31 so as to be able to reciprocate, and a second regenerator 35 is disposed in the second cylinder 32 so as to be able to reciprocate. Sealing rings 36 and 37 are disposed between the first cylinder 31 and the first regenerator 34 and between the second cylinder 32 and the second regenerator 35, respectively.

A first expansion chamber 41 is provided between a connection portion of the first regenerator 34 and the second regenerator 35 and an inner wall of the first cylinder 31. A second expansion chamber 42 is provided between the second regenerator 35 and the distal end wall of the second cylinder 32. A first cooling stage 43 is formed at the bottom of the first expansion chamber 41, and a second cooling stage 44 having a lower temperature than the first cooling stage 43 is formed at the bottom of the second expansion chamber 42.

The first regenerator 34 accommodates a first regenerator material 38 such as a copper alloy mesh in a state where a passage 33 for the working gas (He gas or the like) is secured. As the first regenerator material 38, a stainless-steel mesh may be used instead of the copper alloy mesh, or both of them may be used. The second regenerator 35 is filled with a second regenerator material 40 in a form in which a passage 39 for the working gas is secured. Although the first regenerator material 38 and the second regenerator material 40 are separately filled in the regenerators 34 and 35, respectively, they may be filled in one regenerator.

The second regenerator material 40 accommodated in the second regenerator 35 is filled with a plurality of types of second regenerator materials 40a and 40b partitioned by a mesh 48. The filling rate of the second regenerator materials 40a and 40b in the space partitioned by the mesh 48 is preferably 50% to 75%, and more preferably 55% to 65%, in consideration of the fluidity of the working gas.

In the two-stage refrigerator 30, a working gas (He gas or the like) is compressed by a compressor 45 and supplied to the refrigerator 30 through a high-pressure line 46. The supplied working gas passes through the gaps in the first regenerator material 38 accommodated in the first regenerator 34, reaches the first expansion chamber 41, and cools the first cooling stage 43 by expansion. Next, the working gas passes through the gaps in the second regenerator material 40 accommodated in the second regenerator 35, reaches the second expansion chamber 42, and cools the second cooling stage 44 by expansion.

The working gas at a low pressure passes through the second regenerator 35 and the first regenerator 34 in this order (in the opposite direction to the case of a high pressure), and is returned to the compressor 45 through the low-pressure line 47. Thereafter, the gas is compressed by the compressor 45, and the cycle is repeated. The expansion in the expansion chambers 41 and 42 is realized by the reciprocating operation of the regenerators 34 and 35. At this time, the respective regenerator materials 38, 40 store and hold cold by giving and receiving thermal energy to and from the working gas, and perform thermal regeneration.

Next, the above-mentioned cycle will be described by focusing on the flow of heat. The high-pressure working gas supplied from the compressor 45 to the refrigerator 30 is approximately at the normal-temperature (˜300K), and is precooled by the first regenerator material 38 when passing through the first regenerator 34, and reaches the first expansion chamber 41. The temperature of the working gas is further lowered by expansion in the first expansion chamber 41, and the first cooling stage 43 is cooled. Subsequently, the working gas is pre-cooled by the second regenerator material 40 when passing through the second regenerator 35, and reaches the second expansion chamber 42. The temperature of the working gas is further lowered by expansion in the second expansion chamber 42, and the second cooling stage 44 is cooled.

The working gas at a low pressure passes through the second regenerator 35 while storing cold energy in the second regenerator material 40 (while the working gas itself is warmed). Subsequently, the working gas is warmed to near room temperature while passing through the inside of the first regenerator 34 while storing cold energy in the first regenerator material 38 (while the working gas itself is warmed), and returns to the compressor 45 through the low-pressure line 47.

During the steady operation of the refrigeration cycle, a temperature gradient is generated in the regenerator materials 38 and 40 in the regenerators 34 and 35. In such a refrigeration cycle, as the specific heat of the regenerator material at the operating temperature is higher, the thermal efficiency of the working gas cycle is improved, a lower temperature is realized, and high refrigeration performance is obtained.

In general, the specific heat of a solid varies depending on the temperature. Therefore, in order to enhance the heat recovery effect of the second regenerator material 40, it is effective to selectively dispose the second regenerator material 40 having a good heat recovery characteristic in each temperature range in accordance with the temperature gradient. Accordingly, the second regenerator 35 is filled with a plurality of second regenerator materials 40 (40a, 40b) having different heat recovery characteristics.

In order to obtain a good heat recovery effect, it is important that the heat capacity (specific heat) of the regenerator material at the operating temperature of each portion in the cycle process is high, and that the heat exchange between the regenerator materials 40 and 38 and the working gas is efficient. In the first regenerator 34, since a temperature range from room temperature to 100K or lower is a main operation temperature range, Cu having a large specific heat per unit area in this temperature range is selected, and since a wire-drawn mesh is industrially easily used, a Cu mesh is widely used as the first regenerator material 38.

When the temperature is equal to or lower than 60K, Pb or Bi having a specific heat higher than Cu is selected as the second regenerator material 40a on the high temperature side of the second regenerator 35. Further, when the temperature becomes equal to or lower than 8K, the regenerator material having the ThCr₂Si₂-type crystal structure according to the first embodiment, which has a specific heat higher than Pb or Bi, is selected as the second regenerator material 40b on the low temperature side of the second regenerator 35. The regenerator material according to the embodiment exhibits high specific heat characteristics in a cryogenic temperature region, and thus contributes to stable operation of a refrigerator. As described above, it is preferable that the regenerator materials 38 and 40 of the GM refrigerator are disposed by selecting a material having a large volumetric specific heat in the operating temperature range of each portion in consideration of the temperature gradient inside the regenerators 34 and 35. The second regenerator material 40a disposed on the high-temperature side of the second regenerator 35 is not limited to Pb or Bi, and HoCu₂, Er₃Ni, or the like may be disposed. The second regenerator material 40 is not limited to the above-described two layers, and three or more layers may be formed.

The refrigerator including the regenerator material according to the first embodiment is not limited to the GM refrigerator described above. In a refrigerator that generates a cryogenic temperature from room temperature, such as a pulse tube refrigerator, a Claude refrigerator, or a Stirling refrigerator, the regenerator material according to the embodiment is used in a portion where a large thermal impedance is required, such as a boundary region between a cold portion and a hot portion generated in a compression/expansion cycle of a working gas. Thus, a refrigerator having higher specific heat characteristics in a cryogenic temperature region can be provided.

### Third Embodiment

In the third embodiment, a superconducting coil incorporating apparatus will be described. The superconducting coil incorporating apparatus according to the embodiment includes the refrigerator according to the second embodiment.

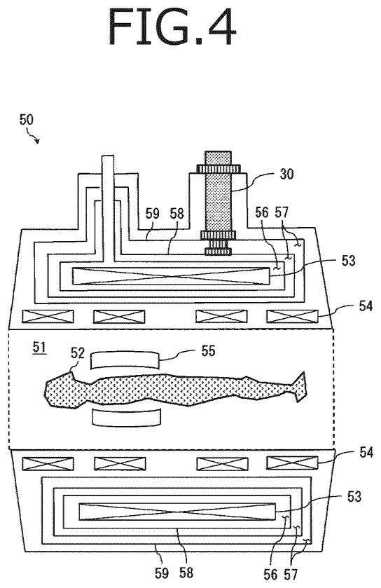

FIG. 4 is a cross-sectional view of a magnetic resonance imaging (MRI) apparatus 50 illustrating an example of a superconducting coil incorporating apparatus according to the third embodiment. In the diagnosis by the MRI apparatus 50, a movable table (not shown) on which the subject 52 lies is moved into the tunnel-like bore space 51. Then, a static magnetic field is applied by the first electromagnet 53, and a gradient magnetic field is applied by the second electromagnet 54.

Further, the RF coil 55 transmits radio waves, and receives magnetic resonance signals from the subject 52. The information of the generation position of the response signal is simultaneously received by the presence of the gradient magnetic field. The received response signal is analyzed by a signal processing system (not shown) to reconstruct an image of the inside of the subject 52.

In a typical MRI apparatus 50 currently in use, a superconducting coil that generates a high magnetic field such as 1.5 T or 3 T is used as the first electromagnet 53. As the magnetic field is higher, the signal/noise (S/N) ratio of the magnetic resonance signal is improved, and a clearer image can be captured. The superconducting coil used for the first electromagnet 53 is usually a solenoid coil formed by winding a metallic cryogenic temperature superconducting wire such as NbTi or Nb₃Sn.

Since these wires must be maintained at a temperature below the critical superconducting transition temperature, the first electromagnet 53 is disposed in a He bath 56 filled with liquid He which liquefies at a temperature below 4.2K at 1 atm. Since liquid He is rare and expensive, a heat-insulating vacuum layer 57 is provided outside the He bath 56 in order to suppress evaporation of liquid He. Further, in order to reduce the influence of thermal intrusion from the environment (room temperature: about 300K) in which the MRI apparatus 50 is installed, two radiation shields 58 and 59 are provided in the heat-insulating vacuum layer 57. The radiation shield 58 is cooled to about 4K and the shield 59 is cooled to about 40K by the refrigerator 30.

The refrigerator 30 is not particularly limited, and a combination of a GM refrigerator and a JT refrigerator may be used, or a refrigerator such as a GM refrigerator, a pulse tube refrigerator, a Claude refrigerator, or a Stirling refrigerator may be used alone. In particular, the GM refrigerator has been widely used in the MRI apparatus 50 at the time of filing of the present application, because the refrigeration performance of the GM refrigerator has been improved by mounting a magnetic regenerator material in the 1990s, and the cryogenic temperature equal to or lower than the liquid He temperature can be generated only by the GM refrigerator.

As shown in FIG. 4, the first cooling stage 43 (FIG. 3) of the GM refrigerator 30 and the shield 59 are connected, and the second cooling stage 44 (FIG. 3) and the radiation shield 58 are connected. At the time of filing of the application, GM refrigerators capable of stably obtaining a refrigerating capacity equal to or higher than that of 1W in 4K have been widely used. Therefore, by balancing the thermal intrusion into the He bath 56 and the cooling by the GM refrigerator 30, the cryogenic temperature can be maintained, and the evaporation of the liquid He can be suppressed almost completely.

Thus, in a medical institution such as a hospital, if liquid He is supplied at the time of initial start-up of the MRI apparatus 50, it is not necessary to periodically replenish liquid He, which is expensive and not easy to handle, in the subsequent operation. Such a significant improvement in convenience has led to widespread introduction of the MRI apparatus 50 into small and medium-sized hospitals. Further, an MRI apparatus incorporating a direct-cooling type superconducting coil which is cooled by conductively by a refrigerator without using liquid He has been commercialized. In this case, the He bath 56 can be omitted.

In recent years, MRI apparatuses using high-temperature superconducting wires such as Y-based, Bi-based, and MgB₂ superconducting wires have been developed. Similar to MRI devices using low-temperature superconducting materials, the superconducting coil in these devices must be cooled below the critical temperature of superconducting transition and to a temperature lower than 30K at which the current required for generating a magnetic field can be passed.

Therefore, in the MRI apparatus using the high-temperature superconducting material, it is necessary to cool the superconducting coil by immersing the superconducting coil in liquid He, H₂, or Ne whose liquefaction temperature under 1 atm is equal to or lower than 30K, or to cool the superconducting coil by conduction using a refrigerator. In the former method, it is also preferable to cool the liquid He, H₂ and Ne by using a refrigerator to suppress the evaporation of the liquid He, H₂ and Ne. In order to improve the performance of the refrigerator in the temperature range from 10K to 30K, it is preferable to mount a regenerator material having a high specific heat in the same temperature range on the refrigerator.

The superconducting coil incorporating apparatus according to the third embodiment is equipped with the refrigerator according to the second embodiment, which includes the regenerator material according to the first embodiment. Thus, a superconducting coil incorporating efficient operation can be apparatus capable of more provided.

### (Manufacturing Method)

A method for manufacturing the regenerator material will be described. The method for manufacturing a regenerator material according to the embodiment is, for example, the method for manufacturing a regenerator material according to the first embodiment. The method for manufacturing a regenerator material according to the embodiment includes a melting step of melting elements mixed to have a desired stoichiometric ratio to obtain a compound, a cooling step of cooling and solidifying the compound, and a heat treatment step of heat-treating the cooled compound at a temperature of 1000° C. or more and a melting point or less for 24 hours or more.

In the melting step, the components are mixed and melted so as to have a desired stoichiometric ratio. The melting may be performed by any method as long as the elements are melted, and examples thereof include high-frequency induction heating and arc melting.

In the cooling step, the compound that has been melted in the melting step is cooled and solidified. The cooling may be performed by any method as long as the compound is solidified, and for example, the cooling can be performed at a cooling rate of 50° C./s or more. This makes it possible to obtain the compound in the form of particles with excellent specific heat characteristics. Molten metal is supplied to the running surface of a high-speed rotor installed in a vacuum or inert gas atmosphere. The molten metal is finely dispersed by the motion of the rotor and simultaneously rapidly solidified to form spherical particles. Alternatively, the molten metal is allowed to flow out into a vacuum or an inert gas atmosphere, and a non-oxidizing atomizing gas is allowed to act on the molten metal. As a result, the molten metal is atomized and dispersed, and at the same time, rapidly cooled and solidified to form spherical particles. The cooling may be natural cooling.

Examples of such a methods include a rotary disc process (RDP), a single roll process, a twin roll process, an inert gas atomization process, and a rotary nozzle process. By these methods, the regenerator material particles can be obtained very simply and at low cost. The cooled regenerator material particles are preferably spherical.

In the heat treatment step, the solidified compound is heat-treated. The heat treatment is carried out at 1000° C. or more and the melting point of the compound or less for at least 24 hours. The melting point of the compound can be measured in advance by using differential scanning calorimetry (DSC). The heat treatment time is preferably 72 hours or more. This causes the crystalline phase to grow and the grain size to increase, and thus the integral value of the specific heat peak in 2K to 5K can be increased. The heat treatment is preferably carried out at a temperature of 1200° C. or higher, but below the melting point of the compound. This makes it possible to increase the integral value of the specific heat peak in 2K to 5K without melting the compound again.

The regenerator material manufactured in this way is heat-treated at a high temperature equal to or lower than the melting point, resulting in a regenerator material with higher specific heat characteristics in the cryogenic temperature region.

### Example 1

Example 1 will be described. Each element with a purity of 99.9% or more was weighed as a raw material so that the composition was Er₂₀Fe₄₀Si₄₀. Next, the elements were melted by arc melting and then cooled to prepare a bulk sample. The composition of the bulk sample was confirmed as Er₂₀Fe₄₀Si₄₀ by analysis using inductively coupled plasma (ICP) emission spectrometry. The bulk sample was subjected to heat treatment at 1200° C. for 72 hours to form a sample.

### Examples 2 to 17, Comparative Examples 1 to 12

### Example 2

A bulk sample was prepared in the same manner as in Example 1 except that the composition was changed to Er₁₇Fe₃₅Si₄₈.

### Example 3

A bulk sample was prepared in the same manner as in Example 1 except that the composition was changed to Er₁₅Fe₃₈Si₄₇.

### Example 4

A bulk sample was prepared in the same manner as in Example 1 except that the composition was changed to Er₂₁Fe₄₄Si₃₅.

### Example 5

A bulk sample was prepared in the same manner as in Example 1 except that the composition was changed to Er₂₅Fe₄₁Si₃₄.

### Example 6

A bulk sample was prepared in the same manner as in Example 1 except that the composition was changed to Er₁₉Fe₄₅Si₃₆.

### Example 7

A bulk sample was prepared in the same manner as in Example 1 except that a part of Er was substituted with Gd, Er and Gd were mixed at a composition ratio of 9:1, and the composition was changed to (Er_{0.9}Gd_{0.1})₂₁Fe₄₁Si₃₈.

### Example 8

A bulk sample was prepared in the same manner as in Example 1 except that a part of Er was substituted with Ho, and Er and Ho were mixed at a composition ratio of 9:1, and the composition was changed to (Er_{0.9}Ho_{0.1})₂₂Fe₃₉Si₃₉.

### Example 9

A bulk sample was prepared in the same manner as in Example 1 except that a part of Er was substituted with Dy, and Er and Dy were mixed at a composition ratio of 9:1, and the composition was changed to (Er_{0.9}Dy_{0.1})₁₉Fe₄₁Si₄₀.

### Example 10

A bulk sample was prepared in the same manner as in Example 1 except that a part of Er was substituted with Y, Er and Y were mixed at a composition ratio of 9:1, and the composition was changed to (Er_{0.9}Y_{0.1})₁₉Fe₄₀Si₄₁.

### Example 11

A bulk sample was prepared in the same manner as in Example 1 except that a part of Er was substituted with Tb, Er and Tb were mixed at a composition ratio of 9:1, and the composition was changed to (Er_{0.9}Tb_{0.1})₂₀Fe₄₁Si₃₉.

### Example 12

A bulk sample was prepared in the same manner as in Example 1 except that a part of Er was substituted with Sm, and Er and Sm were mixed at a composition ratio of 9:1, and the composition was changed to (Er_{0.9}Sm_{0.1})₁₉Fe₄₁Si₄₀.

### Example 13

A bulk sample was prepared in the same manner as in Example 1 except that a part of Fe was substituted with Co, and Fe and Co were mixed at a composition ratio of 9:1, and the composition was changed to Er₂₁(Fe_{0.9}Co_{0.1})₄₁Si₃₈.

### Example 14

A bulk sample was prepared in the same manner as in Example 1 except that a part of Fe was substituted with Mn, and Fe and Mn were mixed at a composition ratio of 9:1, and the composition was changed to Er₂₀(Fe_{0.9}Mn_{0.1})₃₈Si₄₂.

### Example 15

A bulk sample was prepared in the same manner as in Example 1 except that a part of Fe was substituted with Ni, and Fe and Ni were mixed at a composition ratio of 9:1, and the composition was changed to Er₂₂(Fe_{0.9}Ni_{0.1})₃₇Si₄₁.

### Example 16

A bulk sample was prepared in the same manner as in Example 1 except that a part of Si was substituted with Ge, and Si and Ge were mixed at a composition ratio of 9:1, and the composition was changed to Er₂₁Fe₃₉(Si_{0.9}Ge_{0.1})₄₀.

### Example 17

A bulk sample was prepared in the same manner as in Example 1 except that a part of Si was substituted with Ga, and Si and Ga were mixed at a composition ratio of 9:1, and the composition was changed to Er₁₉Fe₃₉(Si_{0.9}Ga_{0.1})₄₂.

### Example 18

A bulk sample was prepared by the arc melting method in the same manner as in Example 1 by using a composition of Er₂₁Fe₃₉Si₄₀, and was subjected to heat treatment at 1200° C. for 24 hours.

### Example 19

A bulk sample was prepared by the arc melting method in the same manner as in Example 1 by using a composition of Er₂₀Fe₃₉Si₄₁, and was subjected to a heat treatment at 1200° C. for 360 hours.

### Example 20

A bulk sample was prepared by the arc melting method in the same manner as in Example 1 by using a composition of Er₂₀Fe₃₉Si₄₁, and was subjected to a heat treatment at 1200° C. for 480 hours.

### Example 21

A bulk sample was prepared by the arc melting method in the same manner as in Example 1 by using a composition of Er₂₀Fe₃₉Si₄₁, and was subjected to a heat treatment at 1200° C. for 720 hours.

### Example 22

A bulk sample was prepared by the arc melting method in the same manner as in Example 1 by using a composition of Er₂₀Fe₃₉Si₄₁, and was subjected to a heat treatment at 1200° C. for 1440 hours.

### Comparative Example 1

A bulk sample was prepared in the same manner as in Example 1 except that the composition was changed to Er₁₄Fe₃₂Si₅₄.

### Comparative Example 2

A bulk sample was prepared in the same manner as in Example 1 except that the composition was changed to Er₁₃Fe₅₀Si₃₇.

### Comparative Example 3

A bulk sample was prepared in the same manner as in Example 1 except that the composition was changed to Er₂₃Fe₂₉Si₄₈.

### Comparative Example 4

A bulk sample was prepared in the same manner as in Example 1 except that the composition was changed to Er₂₁Fe₃₄Si₄₅.

### Comparative Example 5

A bulk sample was prepared in the same manner as in Example 1 except that the composition was changed to Er₂₀Fe₅₂Si₂₈.

### Comparative Example 6

A bulk sample was prepared in the same manner as in Example 1 except that the composition was changed to Er₂₇Fe₃₂Si₄₁.

### Comparative Example 7

A bulk sample was prepared in the same manner as in Example 1 except that the composition was changed to Er₂₆Fe₄₈Si₂₆.

### Comparative Example 8

A bulk sample was prepared in the same manner as in Example 1 except that the composition was changed to Er₂₂CO₃₈Si₄₀.

### Comparative Example 9

A bulk sample was prepared in the same manner as in Example 1 except that the composition was changed to Er₁₉Ni₄₁Si₄₀.

### Comparative Example 10

A bulk sample was prepared in the same manner as in Example 1 except that the composition was changed to Er₂₀Cu₃₈Si₄₂.

### Comparative Example 11

A bulk sample was prepared in the same manner as in Example 1 except that the composition was changed to Gd₂₁Fe₃₉Si₄₀.

### Comparative Example 12

A bulk sample was prepared in the same manner as in Example 1 except that the composition was changed to HO₁₈Fe₄₂Si₄₀.

### Comparative Example 13

A bulk sample was prepared by the arc melting method in the same manner as in Example 1, except that the composition was Er₂₁Fe₃₉Si₄₀, and the heat treatment was not performed.

### Comparative Example 14

A bulk sample was prepared by the arc melting method in the same manner as in Example 1 by using a composition of Er₁₉Fe₄₀Si₄₁, and was subjected to a heat treatment at 800° C. for 168 hours.

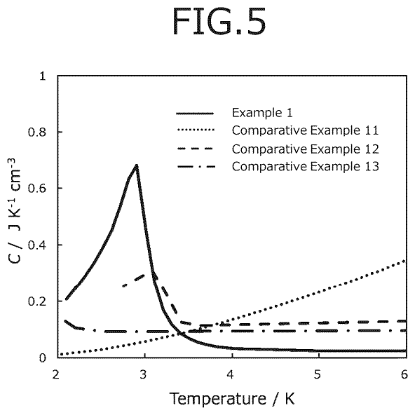

FIG. 5 is a graph showing the specific heat characteristics from 2K to 6K of Example 1 and Comparative Examples 11 to 13. The specific heat characteristics were measured using a physical property measurement (PPMS®) manufactured by Quantum Design, Inc. As can be seen from FIG. 5, it is found that the local maximum value of the specific heat in 2K to 5K is higher in Example 1 than in Comparative Example 11 to Comparative Example 13. Thus, by adopting the regenerator material according to the first embodiment as the regenerator material filled in the regenerator of the refrigerator, the cooling capacity of the refrigerator is improved.

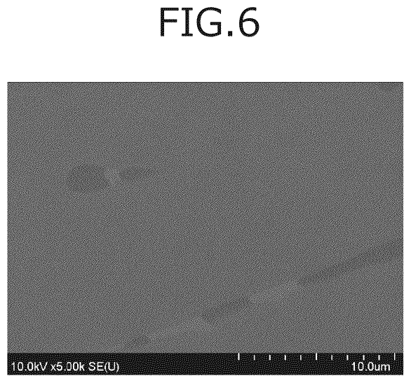

FIG. 6 is a SEM image of the sample of Example 1 observed at 5000× magnification. The SEM image was obtained using a scanning electron microscope (FE-SEM SU8020) manufactured by Hitachi High-Technologies Corporation. As shown in FIG. 6, it is understood that the grain boundary phase having a contrast different from that of the main phase exists. The results of the composition analysis of each point using EDX revealed that, in addition to the main phase composed of Er, Fe and Si, a compound containing one or more compounds selected from compounds represented by the composition formula Fe_{c}Si_{100-c} (45≤c≤55) or Er_{d}FeₑSi_{f}O_{100-d-e-f} (10≤d≤20, 20≤e≤30, 40≤f≤50) was present as a grain boundary phase.

Tables 1 and 2 show the composition, the integral value of the specific heat peak from 2K to 5K, and the crystal grain size in Examples 1 to 19 and Comparative Examples 1 to 14. When the example 1 is compared with the comparative examples 7 to 12, it is found that the combination of Er, Fe, and Si exhibits a higher specific heat than the combinations of other elements at 5K or below. Further, even when a part of Er, Fe, or Si is substituted with other rare earth elements, a high specific heat integral value is obtained.

TABLE 1

| | | Integral value | Crystal |
|---|---|---|---|
| | | of the specific | grain |
| | | heat peak | size |
| | Composition | @2-5K(J · cm⁻³) | (mm) |
| Example 1 | Er₂₀Fe₄₀Si₄₀ | 0.53 | 0.0371 |
| Example 2 | Er₁₇Fe₃₅Si₅₈ | 0.53 | 0.0493 |
| Example 3 | Er₁₅Fe₃₈Si₄₇ | 0.53 | 0.0382 |
| Example 4 | Er₂₁Fe₄₄Si₃₅ | 0.54 | 0.0492 |
| Example 5 | Er₂₅Fe₄₁Si₃₃ | 0.54 | 0.0195 |
| Example 6 | Er₁₉Fe₄₅Si₃₆ | 0.54 | 0.0284 |
| Example 7 | (Er_{0.9}Gd_{0.1})₂₁Fe₄₁Si₃₈ | 0.56 | 0.0175 |
| Example 8 | (Er_{0.9}Ho_{0.1})₂₂Fe₃₉Si₃₉ | 0.53 | 0.0462 |
| Example 9 | (Er_{0.9}Dy_{0.1})₁₉Fe₄₁Si₄₀ | 0.55 | 0.0456 |
| Example 10 | (Er_{0.9}Y_{0.1})₁₉Fe₄₀Si₄₁ | 0.54 | 0.0499 |
| Example 11 | (Er_{0.9}Tb_{0.1})₂₀Fe₄₁Si₃₉ | 0.54 | 0.0320 |
| Example 12 | (Er_{0.9}Sm_{0.1})₁₉Fe₄₁Si₄₀ | 0.53 | 0.0298 |
| Example 13 | Er₂₁(Fe_{0.9}Co_{0.1})₄₁Si₃₈ | 0.54 | 0.0567 |
| Example 14 | Er₁₉(Fe_{0.9}Mn_{0.1})₃₈Si₄₂ | 0.54 | 0.0269 |
| Example 15 | Er₂₂(Fe_{0.9}Ni_{0.1})₃₇Si₄₁ | 0.55 | 0.0554 |
| Example 16 | Er₂₁Fe₃₉(Si_{0.9}Ge_{0.1})₄₀ | 0.53 | 0.0527 |
| Example 17 | Er₁₉Fe₃₉(Si_{0.9}Ga_{0.1})₄₂ | 0.53 | 0.0295 |
| Example 18 | Er₂₁Fe₃₉Si₄₀ | 0.53 | 0.0010 |
| Example 19 | Er₂₀Fe₃₉Si₄₁ | 0.55 | 0.0998 |
| Example 20 | Er₂₀Fe₃₉Si₄₁ | 0.57 | 0.3325 |
| Example 21 | Er₂₀Fe₃₉Si₄₁ | 0.59 | 0.5799 |
| Example 22 | Er₂₀Fe₃₉Si₄₁ | 0.60 | 0.9732 |

TABLE 2

| | | Integral value | Crystal |
|---|---|---|---|
| | | of the specific | grain |
| | | heat peak | size |
| | Composition | @2-5K(J · cm⁻³) | (mm) |
| Comparative Example 1 | Er₁₄Fe₃₂Si₅₄ | 0.42 | 0.0485 |
| Comparative Example 2 | Er₁₃Fe₅₀Si₃₇ | 0.38 | 0.0108 |
| Comparative Example 3 | Er₂₃Fe₂₉Si₄₈ | 0.26 | 0.0439 |
| Comparative Example 4 | Er₂₁Fe₃₄Si₄₅ | 0.49 | 0.0256 |
| Comparative Example 5 | Er₂₀Fe₅₂Si₂₈ | 0.01 | 0.0162 |
| Comparative Example 6 | Er₂₇Fe₃₂Si₄₁ | 0.41 | 0.0593 |
| Comparative Example 7 | Er₂₆Fe₄₈Si₂₆ | 0.13 | 0.0433 |
| Comparative Example 8 | Er₂₂Co₃₈Si₄₀ | 0.31 | 0.0305 |
| Comparative Example 9 | Er₁₉Ni₄₁Si₄₀ | 0.35 | 0.0556 |
| Comparative Example 10 | Er₂₀Cu₃₈Si₄₂ | 0.29 | 0.0618 |
| Comparative Example 11 | Gd₂₁Fe₃₉Si₄₀ | 0.49 | 0.0229 |
| Comparative Example 12 | Ho₁₈Fe₄₂Si₄₀ | 0.15 | 0.0447 |
| Comparative Example 13 | Er₂₁Fe₃₉Si₄₀ | 0.47 | 0.0007 |
| Comparative Example 14 | Er₁₉Fe₄₀Si₄₁ | 0.52 | 0.0009 |

As shown in Tables 1 and 2, the crystal grain size varies depending on the heat treatment conditions, and the crystal grain size exceeds 0.001 mm by performing the heat treatment at a temperature of 1000° C. or higher, and a specific heat integral value from 2K to 5K exceeding the value of the sample manufactured under the same conditions as described in D. S. Wang, et. al., Chem. Mater., 36 (2024) 1707-1718, is obtained.

In the present embodiment, a method for manufacturing a regenerator material with high specific heat characteristics and mechanical strength in a cryogenic temperature region is provided.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. These embodiments and modifications thereof are included in the scope and spirit of the invention, and are included in the invention described in the claims and the scope of equivalents thereof.

The invention of the embodiment will be described below.

<1>

A regenerator material including:
an intermetallic compound represented by a composition formula ErₐFe_{b}Si_{100-a-b} (where 15≤a≤25, and 35≤b≤45), wherein
the intermetallic compound has a crystalline phase with a ThCr₂Si₂-type crystal structure as a main phase, and a crystal grain size of the main phase is 0.001 mm or more and 1 mm or less.
   <2>

The regenerator material according to <1>, wherein
a part of Er is substituted with R (R is one or more elements selected from the group consisting of La, Ce, Pr, Nd, Pm, Sm, Eu, Gd, Tb, Dy, Ho, Tm, Yb, Lu, Sc and Y).
   <3>

The regenerator material according to any one of <1> to <2>, wherein
a part of Fe is substituted with T (T is one or more elements selected from the group consisting of Ti, V, Cr, Mn, Co, Ni, Cu, Nb, Zr, Mo, Ru, Rh, Pd, and Ag).
   <4>

The regenerator material according to any one of <1> to <3>, wherein
a part of Si is substituted with X (X is one or more elements selected from the group consisting of B, Al, P, Ga, Ge, As, Sn, Sb, and Te).
   <5>

The regenerator material according to any one of <1> to <4>, further including:
one or more compounds represented by a composition formula Fe_{c}Si_{100-c} (where 45≤c≤55) or Er_{d}FeₑSi_{f}O_{100-d-e-f} (where 10≤d≤20, 20≤e≤30, and 40≤f≤50).
   <6>

The regenerator material according to any one of <1> to <5>, wherein
a part of Er in the compound represented by the composition formula Fe_{c}Si_{100-c} (where 45≤c≤55) or Er_{d}FeₑSi_{f}O_{100-d-e-f} (where 10≤d≤20, 20≤e≤30, and 40≤f≤50) is substituted with R (where R is one or more elements selected from the group consisting of La, Ce, Pr, Nd, Pm, Sm, Eu, Gd, Tb, Dy, Ho, Tm, Yb, Lu, Sc, and Y),
a part of Fe is substituted with T (where T is one or more elements selected from the group consisting of Ti, V, Cr, Mn, Co, Ni, Cu, Nb, Zr, Mo, Ru, Rh, Pd, and Ag), and
a part of Si is substituted with X (where X is one or more elements selected from the group consisting of B, Al, P, Ga, Ge, As, Sn, Sb, and Te).
   <7>

The regenerator material according to any one of <1> to <6>, wherein
the particle diameter of the particles is 0.01 mm or more and 1 mm or less.
   <8>

The regenerator material according to any one of <1> to <7>, wherein
the particle diameter of the particles is 0.01 mm or more and 1 mm or less.
   <9>

A refrigerator including the regenerator material according to any one of <1> to <8>.

<10>

A superconducting coil incorporating apparatus including:
the refrigerator according to <9>.
   <11>

A method for manufacturing the regenerator material according to any one of <1> to <8>, including:
a melting step of melting elements mixed to have a desired stoichiometric ratio to obtain an intermetallic compound with a ThCr2Si2-type crystal structure,
a cooling step of cooling and solidifying the compound, and
a heat treatment step of heat-treating the cooled compound at a temperature of 1000° C. or more and a melting point or less for 24 hours or more.

What is claimed is:

1. A regenerator material comprising:
an intermetallic compound represented by a composition formula ErₐFe_{b}Si_{100-a-b} (where 15≤a≤25, and 35≤b≤45), wherein
the intermetallic compound has a crystalline phase with a ThCr₂Si₂-type crystal structure as a main phase, and a crystal grain size of the main phase is 0.001 mm or more and 1 mm or less.

2. The regenerator material according to claim 1, wherein
a part of Er is substituted with R (R is one or more elements selected from the group consisting of La, Ce, Pr, Nd, Pm, Sm, Eu, Gd, Tb, Dy, Ho, Tm, Yb, Lu, Sc and Y).

3. The regenerator material according to claim 1, wherein
a part of Fe is substituted with T (T is one or more elements selected from the group consisting of Ti, V, Cr, Mn, Co, Ni, Cu, Nb, Zr, Mo, Ru, Rh, Pd, and Ag).

4. The regenerator material according to claim 1, wherein
a part of Si is substituted with X (X is one or more elements selected from the group consisting of B, Al, P, Ga, Ge, As, Sn, Sb, and Te).

5. The regenerator material according to claim 1, further comprising:
one or more compounds represented by a composition formula Fe_{c}Si_{100-c} (where 45≤c≤55) or Er_{d}FeₑSi_{f}O_{100-d-e-f} (where 10≤d≤20, 20≤e≤30, and 40≤f≤50).

6. The regenerator material according to claim 5, wherein
a part of Er in the compound represented by the composition formula Fe_{c}Si_{100-c} (where 45≤c≤55) or Er_{d}FeₑSi_{f}O_{100-d-e-f} (where 10≤d≤20, 20≤e≤30, and 40≤f≤50) is substituted with R (where R is one or more elements selected from the group consisting of La, Ce, Pr, Nd, Pm, Sm, Eu, Gd, Tb, Dy, Ho, Tm, Yb, Lu, Sc, and Y),
a part of Fe is substituted with T (where T is one or more elements selected from the group consisting of Ti, V, Cr, Mn, Co, Ni, Cu, Nb, Zr, Mo, Ru, Rh, Pd, and Ag), and
a part of Si is substituted with X (where X is one or more elements selected from the group consisting of B, Al, P, Ga, Ge, As, Sn, Sb, and Te).

7. The regenerator material according to claim 1, wherein
the crystal grain size of the main phase is 0.001 mm or more and 0.1 mm or less.

8. The regenerator material according to claim 1, wherein
the particle diameter of the particles is 0.01 mm or more and 1 mm or less.

9. A refrigerator comprising:
the regenerator material according to claim 1.

10. A superconducting coil incorporating apparatus comprising:
the refrigerator according to claim 9.

11. A method for manufacturing the regenerator material according to claim 1, comprising:
a melting step of melting elements mixed to have a desired stoichiometric ratio to obtain an intermetallic compound with a ThCr₂Si₂-type crystal structure,
a cooling step of cooling and solidifying the compound, and
a heat treatment step of heat-treating the cooled compound at a temperature of 1000° C. or more and a melting point or less for 24 hours or more.
